(19) United States
(12) Patent Application Publication
(10) Pub. No.: US 2022/0060528 A1
(43) Pub. Date: Feb. 24, 2022

(54) END-TO-END SYSTEM FOR STREAMING OF MULTIMEDIA CONTENTS ON WIRELESS NETWORKS

(71) Applicant: ABLIO S.R.L., ROMA (RM) (IT)

(72) Inventors: Luigi LORETI, ROMA (RM) (IT); Piergiorgio FIANDANESE, ROMA (RM) (IT); Giulio MONACO, ROMA (RM) (IT)

(21) Appl. No.: 17/415,577

(22) PCT Filed: Dec. 10, 2019
(86) PCT No.: PCT/IB2019/060609

§ 371 Date: Jun. 17, 2021

(30) Foreign Application Priority Data
Dec. 18, 2018 (IT) 102018000020044

(51) Int. Cl. H04L 29/06; H04L 1/00

(52) U.S. Cl. CPC H04L 65/4076; H04W 84/12; H04L 65/4084; H04L 1/0041

(57) ABSTRACT

An end-to-end system for the multimedia distribution over a Wi-Fi network uses a wireless multicast transmission mode that uses new communication protocols for high quality of service with many concurrent users; the system allows using Wi-Fi Access Points for media content streaming, without new hardware; the system handles automatic configuration, preparation, and management of all the network traffic in end-to-end mode; the multimedia contents can come from any source, including local or remote file servers, or captured live; the contents are directly received on the final clients' mobile devices using an application that configures the device for appropriate data reception; the multimedia streaming system are independent from the user's infrastructure. The system includes four main elements: One main broadcasting module; One automatic configuration module of the Wi-Fi network; One automatic configuration module for mobile applications; and One dashboard for modules control and configuration.

This application is the U.S. national phase of International Application No. PCT/IB2019/060609 filed 10 Dec. 2019, which designated the U.S. and claims priority to IT Patent Application No. 102018000020044 filed 18 Dec. 2018, the entire contents of each of which are hereby incorporated by reference.

### BACKGROUND OF THE INVENTION

### Field of the Invention

The present invention operates in the field of multimedia contents distribution through wireless networks. Specifically, the proposed invention concerns a complete solution for an efficient diffusion of multimedia contents on portable devices using Wi-Fi technology with multicast communication.

### Description of the Related Art

At the current state of the art, innumerable solutions are available for the distribution and diffusion of multimedia contents on portable devices. The solutions present in literature use various and disparate technologies, mostly application specific, such as radio or wired broadcasting. In some scenarios, a bidirectional communication is allowed, where the device receiving the contents can in turn communicate with the source of the contents, in order to express preferences or send acknowledgments of reception. The great diffusion of telematics communication networks, including the

Internet, has recently made the distribution of multimedia contents extremely simple, immediate and widespread. Many organizations that manage public areas and spaces—such as stadiums, museums, shopping centres, airports, railway stations, bus companies, university campuses, convention centres, etc. can distribute multimedia materials to their users directly on their portable electronic devices (smart devices) taking advantage of the current technologies and communication protocols. The use of Wi-Fi networks—usually already present in public spaces—can create a direct channel with each individual user, who would then have access to the contents offered free or paid.

One of the fields where the stream of audio/video contents could most benefit from the flexibility and cost-effectiveness of wireless networks, for example, is the field of simultaneous translation during events or conferences. The simultaneous translation is traditionally performed, as per ISO regulations, by a couple of interpreters per language, who listen to the speaker in their headphones and simultaneously translate to an audience of listeners. Current simultaneous translation systems are often based on an infrared (IR) or radiofrequency (RF) transmission technology and include a series of devices:
Control and audio signal transmission units: one or two per event
Service console for the interpreter: one for each interpreter;
Infrared radiant panels or radiofrequency antennas: variable number, depending on the size and type of venue;
Receivers with earphones: one for each listener with related charging units, once again in variable numbers.

Professional interpreters must usually be physically present at the event and operate in special soundproof booths, which must be rented and installed if they are not already available on-site. Each listener receives the simultaneous translation audio signal on a special receiver with earphones that allow to select a specific audio channel corresponding to the desired language. These receivers are handled to the listeners when they enter the event venue, and collected at the end of the event. It is therefore clear that the technical preparation of the system requires time and work and has high management or lease costs, especially in the case of unexpected requirements.

In the cases presented, as well as in other applications where it is necessary to distribute multimedia streams to a large number of users, a possible solution to reduce both costs and technical and managerial complexities consists in exploiting the existing wireless network systems which allow access to the Internet or the internal organization resources. A common problem with wireless networks is that the capacity to transmit an audio/video stream of sufficient quality is hard to predict and drastically decreases as the number of mobile client devices linked to the repeater or Access Point (AP) increase. A high-quality level generally requires the introduction of additional high-quality APs and technical features, suitable for managing a high traffic in relatively small environments. Furthermore, as clients increase, the available bandwidth consumption also increases, which risks to quickly saturate the network resources. A more efficient system could be the multicast-type transmissions, where data packets of a single audio/video stream are transmitted to a large number of nodes, which are registered into a so-called group of recipients of the transmission, thus avoiding the need to transmit the same stream to each client. The first disadvantage of multicast transmission is the absence of the feedback and control channel, i.e. the impossibility of guaranteeing the delivery of a data packet to a specific client/node. Furthermore, the application of this system protocols—which were originally created for wired networks systems—to a wireless network, whose characteristics are extremely variable and dynamic, presents a series of problems:
asymmetric connections, with different and changing performances between downlink and uplink;
variable bandwidths, not predictable or guaranteed;
high probability of packet loss on the channel;
possible loss of membership in the multicast group due to the mobility of the receiving stations from one AP to another.

It is therefore necessary to identify new and more effective traffic management protocols which include appropriate control and error correction systems.

It is internationally possible to find a certain number of patent rights regarding the described problem, such as the US patent US10135947, which concerns the transmission of data packets to several mobile devices connected to an AP, or the Chinese patent CN107371219, which has a method to configure Wi-Fi devices for multicast communication, but none of them completely solves the criticalities explained so far.

### SUMMARY OF THE INVENTION

The present invention consists in a multimedia contents distribution system on a wireless network and effectively solves the afore-mentioned problems, taking advantage of a multicast transmission mode on Wi-Fi networks and introducing communication protocols specifically designed to guarantee a high-quality service with a large number of connected users. This solution allows, advantageously, to use Wi-Fi Access Points as streaming devices for multimedia streams, without the need for a new hardware, using a system that automatically configures, prepares and manages all network traffic in end-to-end mode. The contents can come, advantageously, from local or remote file servers or be streamed live when reproduced. The use of contents takes place directly on the clients' mobile devices (smart devices), by an application that configures the device for the correct data reception. The streaming system of multimedia contents, therefore, specifically concerns the transmission and connectivity segment (traffic management) of communication, and does not affect the user's infrastructure, gaining in terms of costs and management.

The system consists of four main elements, listed and described in more details as follows:
main broadcasting module (engine);
automatic Wi-Fi network configuration module;
automatic configuration module for mobile applications;
control and configuration console (dashboard).

The main module receives the multimedia stream from any source (local media support, file server on LAN or remote network, Internet, real-time streaming, audio/video recording devices, etc.), prepares it for the transmission, and sends it to users on the dedicated Wi-Fi channel. The preparation of the data flow consists, beneficially, in the real-time encapsulation of the incoming multimedia content into a new flow, with characteristics suitable for multicast transmission:
use of a more appropriate and efficient codec that reduces the bandwidth used of by the flow;
UDP/IP packet format;
   application of Forward Error Correction algorithms to mitigate the intrinsic losses of the wireless channel.

The broadcasting engine must be installed on a dedicated computer previously positioned, in the topology of the system, between the multimedia source—to which it is directly or indirectly connected—and at least one wireless router that will be configured for contents distribution, after they are conditioned for Wi-Fi multicast traffic. The main module advantageously includes a DHCP server (Dynamic Host Configuration Protocol) which acts as a local server for the configuration of the addresses and network parameters that the system assigns to the connected mobile devices.

As already mentioned, the broadcasting module advantageously applies a special FEC (Forward Error Correction) algorithm to data flow; this algorithm allows the receiving client station to identify and correct any errors in the input flow due to noise and unreliability of the transmission channel, that otherwise could not be solved due to the lack of error correction mechanisms available in TCP/IP transmission protocols. The FEC mechanism specifically developed for the contents distribution system on a Wi-Fi network consists of three elements: redundancy, regeneration and noise suppression.

In fact, the algorithm is expected to send the same UDP datagram up to four times (redundancy); the receiving station keeps the datagrams in a buffer from where the mobile application retrieves the first datagram correctly received. Since the typical packet loss percentage in a UDP multicast transmission over Wi-Fi is close to 50%, a ratio of 1 to 4 statistically reduces the number of datagrams lost to a value close to zero, and in any case negligible.

In the case of data loss, a special algorithm, incorporated in the mobile application of the receiving station, recovers the missing data by interpolating the entire received flow (best guess).

Finally, the system implements a third correction algorithm that identifies and discards any other undesired signal that is not part of the transmission in progress to reduce the effects of the noise caused by any other devices operating on the same frequencies and channels.

The automatic Wi-Fi network configuration module is installed on the same computer as the broadcasting module or—optionally—on a different device connected to the first one. The configuration module advantageously specifies a suitable configuration for the network devices that are used. The system makes it possible to use all types and models of routers and APs generally available; an automatic or step-by-step guided configuration mode is provided for them, to be performed only once, when the system is installed. The module includes a network diagnostic function, which indicates to the user whether the hardware used is compatible or not with the system. The Wi-Fi network configurator instructs the network devices (at least one) to:

forward the media stream in UDP/IP multicast mode;

recognize and accept at least 64,000 users simultaneously, instead of the 255 addresses typically allowed;

allow the coexistence, optionally, of one or more additional Wi-Fi networks operating in the normal unicast TCP/IP mode, to be used for different purposes, guaranteeing the non-interference with other existing or required Interned-based services.

When the client device (smart device) connects to the Wi-Fi network using the mobile application, the Access Point, advantageously configured:

recognizes the request from the device and accepts its IP address, inserting it in the list of system clients joining the multicast group;

inserts the MAC (Media Access Control) address into its own Client List Journal;

switches the connection to the device in IP multicast mode for the reception of multimedia streams.

The logs of the AP Client List Journal are subsequently available to the other System modules for analysis and statistics production purposes.

The network configuration module can adapt the system to make it function equally: using a dedicated router;

using a router that also serves other networks, possibly dedicated to different purposes;

using several cooperating routers—for example providing a greater service coverage area. Access to the network can be configured, conveniently, either to be free, or protected by cryptography methods (WEP, WPA, WPA2, etc.).

The automatic application configuration module is a software designed for mobile platforms (smartphones, tablets, PDAs, etc.) with the aim of preparing and configuring the applications that will be used for multimedia flows by clients, once they have downloaded them from the most common app stores and installed them on their mobile devices.

The system involves the release of a set of APIs (Application Programming Interface) to implement these applications using third-parties' software.

In addition, the system advantageously includes an application conceived and already configured for the specific reception of audio/video streams.

The control and configuration module (dashboard) is used to manage the entire system with a simple graphic interface and allows to perform two primary functions: the selection of the source and multimedia content to be sent to the broadcasting module, and the configuration of all system settings. In addition, advantageously, the module allows access to analysis and reporting functions.

The control module can be installed on the same computer as the broadcasting module or on a different one connected to it. The module functionalities are accessible both locally and remotely by an easy to use graphic interface and include, but are not limited to:

management of the contents to be distributed;

monitoring of activities, setting and receiving alarms on specific events, etc.;

system administration;

production and analysis of statistical usage data;

creation of event codes to allow the user to select the contents to be displayed;

enabling a test mode to verify the accuracy of the system settings;

receiving and forwarding instant messaging.

The system can recognize and re-transmit audio/video streams and multimedia contents in all the most common formats and transmission and streaming protocols, including but not limited to: HTTP, HLS, HDS, MPEG-DASH, RTSP, RTP, and RTMP.

In one specific embodiment, the multimedia contents distribution system, advantageously, includes a module dedicated to audience control. This module is installed on the same computer as the broadcasting module or on another locally accessible support and provides real-time information on the status of the Wi-Fi network, the number of connections, signal quality, bandwidth usage, etc. This information allows operators, via the control module (dashboard), to intervene with punctual changes and fine-tuning adjustments—such as the settings of the FEC algorithm—to maximize the quality of the service. The module also records information relating to users' behaviour during the use of the system, including contents preferences, average contents use duration, etc. The available information can therefore be used, advantageously, for profiling purposes and to convey the contents more effectively, or for commercial and advertising purposes.

In one specific embodiment, the multimedia contents distribution system includes at least one station per speaker and at least one station for simultaneous interpreters or translators, working locally or remotely, and implements a simultaneous translation system for events or conferences. In this configuration, the system advantageously provides the presence of a local network with possible access to internet. The local network will support:

at least one audio/video acquisition system for one or more speakers

at least one digital console for interpreters

at least one access point

at least one broadcasting module with configurator

at least one mobile device for each participant.

The system can also be configured to allow simultaneous translation of participants intervening during the event.

In one specific embodiment, the multimedia contents distribution system is opportunely implemented using an embedded system consisting of a specific hardware that includes at least one router/AP and at least one mini-PC integrated in a single case. In this embodiment, the mini-PC performs the function of broadcasting, the function of Wi-Fi configurator, and the function of dashboard, further simplifying the system installation and configuration. The same hardware can host, on its internal storage, a media server from which the system takes multimedia contents. In the embedded embodiment, the system can operate even without an Internet connection. Connections with external peripherals (mouse, keyboard, screens, Wi-Fi antennas, communication ports) are integrated in the hardware and advantageously arranged on the rear panel of the case.

The advantages offered by the present invention are evident considering the description given so far and will be even clearer thanks to the annexed figures and the related detailed description.

### BRIEF DESCRIPTION OF THE DRAWINGS

The invention is described hereinafter in at least one preferred embodiment, with the purpose of explaining and not limiting the description, with the support of the accompanying figures, as follows:

FIG. 1 shows the multimedia contents distribution system 100 in a typical configuration. The following are enumerated: broadcasting module 110, Wi-Fi network configurator 120, control and configuration module 130, media server 140, computer where the system is installed 190, recording device 300, connection to the Internet network 600, a Wi-Fi Access Point router 200 and a series of mobile devices 170 connected via a wireless network 500.

FIG. 2 shows a possible system connection scheme. It displays the main computer 190 connected to a multimedia contents server 140 and to the Internet network 600. A wireless Access Point allows one or more smartphones 170 or tablets 180 to access the multicast group 150.

FIG. 3 shows an example of the user interface of the application for mobile devices 171. The following are enumerated: the event selection screen 172, the language selection screen for simultaneous translation 173, the streaming screen 174 with the volume listening controls.

FIG. 4 shows a page of the dashboard 130 where some possible configuration options are highlighted, including: setting of events code 131, activation of demo mode 132, list of available channels 133.

FIG. 5 shows an embodiment of the contents distribution system designed to support simultaneous translation in an event or conference. The following are displayed: speaker's microphone 300, main event camera 310 and acquisition module 320; control computer 190, connected to a local media server 140 and to a remote media server 145 via the Internet 600; broadcasting module 110 connected to the various Access Points 200 through which the simultaneous translation carried out by professional interpreters at their stations 340 is distributed to users 180.

### DESCRIPTION OF THE PREFERRED EMBODIMENTS

The present invention will now be described, by way of example only and not in limiting or binding way, using the figures that show some of the possible embodiments of the proposed inventive concept,

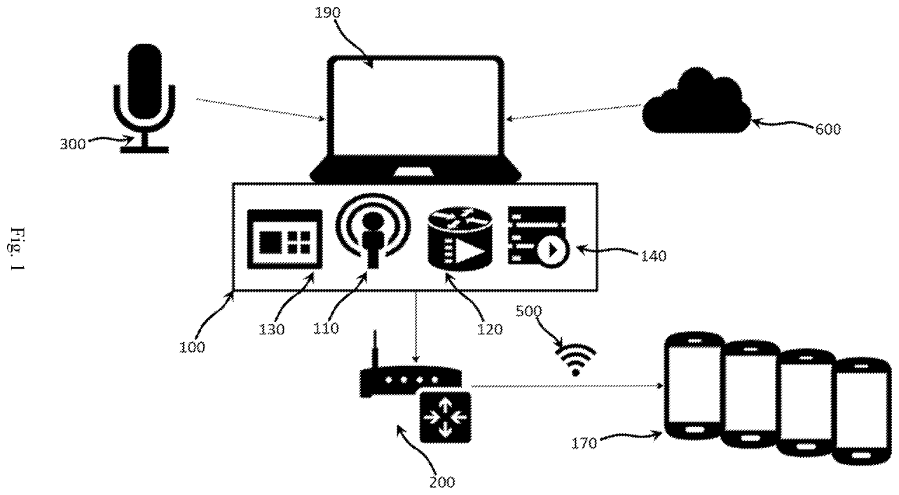

FIG.1 illustrates a typical embodiment of the multimedia contents distribution system on a Wi-Fi network 100, running on a computer 190 and connected to a wireless router 200.

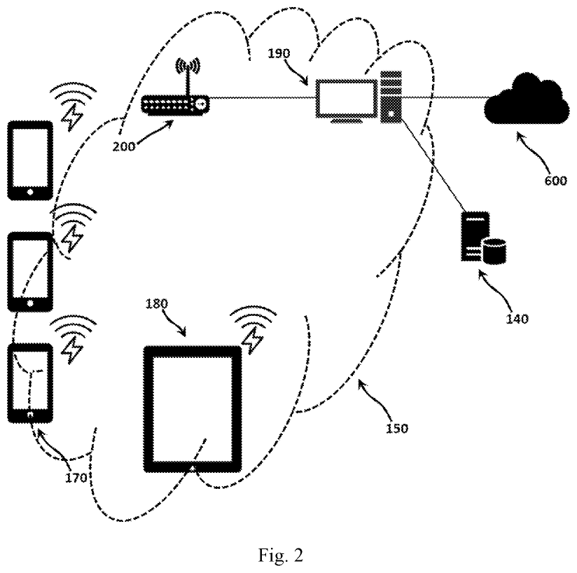

The computer 190 is also endowed with access to the Internet network 600 and to a registration system 300. The network 500 can send multicast packets to the connected devices 170. FIG.2 shows a possible network configuration in detail, where the computer 190 with e system modules configures the router 200 to create a multicast group 150, to which only the devices 170, 180 interested in the distribution of contents are registered.

The system consists of at least four distinct modules shown in FIG. 1:
main broadcasting module (engine) 110;
automatic configuration module for the Wi-Fi network 120;
automatic configuration module for mobile applications;
control and configuration console (dashboard) 130.

Optionally, the system includes other extensions, such as the above-mentioned acquisition devices 300 or local media servers 140 or remote servers releasing the contents for the wireless diffusion.

The main module 110 receives the multimedia stream from any source and predisposes it to be sent over the network via UDP/IP multicast datagrams. The new stream generated in this way:

uses an appropriate codec that reduces bandwidth use during transmission;

applies a Forward Error Correction algorithm at three levels: redundancy, regeneration, noise suppression.

As it is evident in FIG. 2, the engine of broadcasting 110 is preferably installed on a dedicated computer 190 positioned between the multimedia source and at least one wireless router configured for the content distribution. The FEC (Forward Error Correction) algorithm allows the software of mobile devices 170, 180 to identify and correct any errors due to noise and unreliability of the transmission channel The algorithm provides:
the repeated sending of the same UDP datagram up to four times (redundancy);
recovery of missing data by means of an interpolation on the entire flow received (best guess);
a correction algorithm that identifies and discards any signal that is not part of the current transmission.

The automatic configuration module of the Wi-Fi network 120 is preferably installed on the same computer of the broadcasting module and provides to specify an appropriate configuration for the network devices 200. The guided step-by-step configuration is carried out only once, during the system installation. The network configurator 120 instructs the network devices to:
forward the media stream in UDP/IP multicast mode;
recognize and accept a high number (64,000+) of contemporary users;
optionally allow the coexistence of another Wi-Fi.

Furthermore, when the user's device 170, 180 connects to the Wi-Fi network, the system ensures that the network devices:
accept the device request and enter the IP address in the list of system users;
   add the MAC address in their Client List Journal;
   inform the device to switch to IP multicast mode.

The automatic configuration module of applications for mobile platforms 170, 180 takes care of the preparing and configuring the use of multimedia flows.

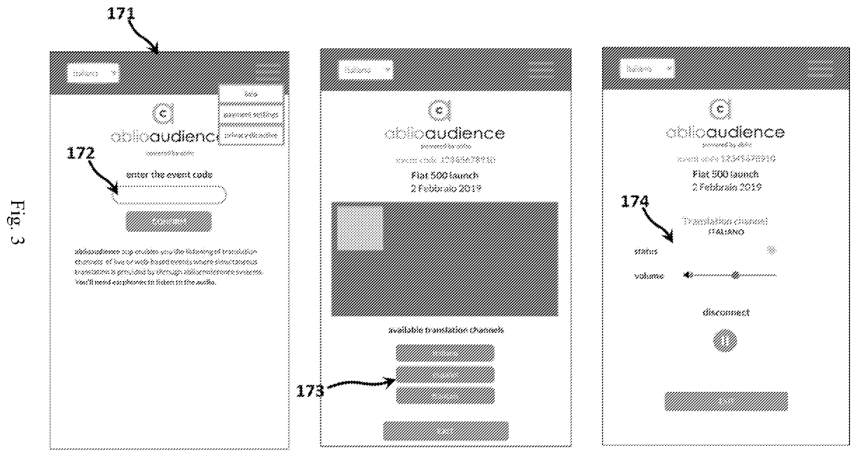

FIG. 3 shows a possible embodiment where the system includes an application conceived and already configured for the specific reception of audio/video streams. The application allows to select the reference event 172 first; then—if available—a preferred listening language 173 for audio streams. Once the communication has started, the user can manage his connection with a specific page 174.

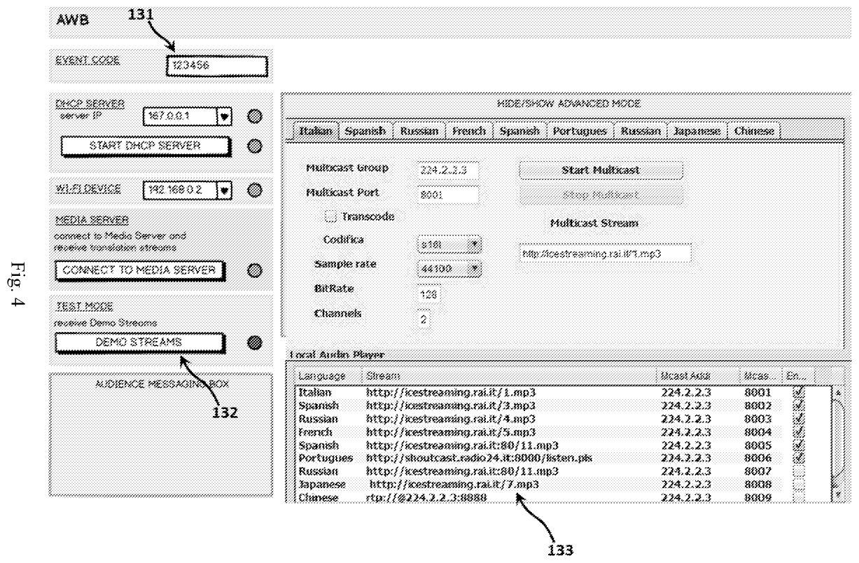

FIG. 4 shows a possible embodiment of the control and configuration module, also called dashboard, which allows to manage the entire system with a simple graphic interface. The module, which is illustrated as a dynamic web page accessible both locally and remotely, allows to:
manage the multimedia contents to be distributed 133 (source selection, events creation, simultaneous translation insertion, etc.);
monitor ongoing activities, set and receive alerts for each specific event, etc.;
manage system parameters;
produce and analyse statistical usage data;
create event codes 131 to allow the user to select the contents to be displayed;
activate the demo test mode 132 in order to verify the accuracy of the system settings;

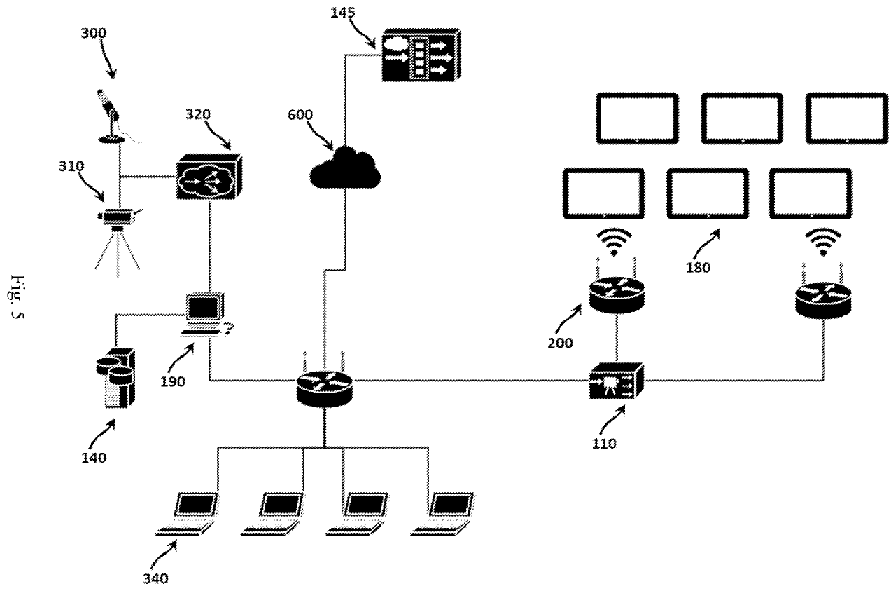

In the preferred embodiment, shown in FIG. 5, the distribution of multimedia contents over a wireless network is used in order to provide a simple and economical simultaneous translation system during an event. In this embodiment, the system includes:
one or more stations per speaker with microphones 300, video recording systems 310, and a digital acquisition system connected to the main computer 190;
at least one dedicated station for simultaneous translation 340 connected to the main computer 190;
at least one local contents server 140 and at least one remote contents server 140 with the possibility of remoting the translation station too;
at least one wireless access point 200
at least one broadcasting module 110 with configurator
at least one mobile device for each participant 180.

Finally, a skilled person can, of course, introduce modifications, additions or variations to the invention described herein, without thereby coming out of the scope of protection, which is provided by the annexed claims.

1. End-to-end system for the distribution of multimedia contents over a Wi-Fi network, utilizing a wireless multicast transmission mode that uses new communication protocols specifically designed to guarantee a high quality service with a large number of users; the above mentioned system allowing the use of Wi-Fi Access Points for media streaming, without need for a new hardware; the above mentioned system handling the automatic configuration, preparation and management of all network traffic in end-to-end mode; above mentioned multimedia contents can come from any source, including but not limited to, local or remote file servers, or be captured live; above mentioned contents being directly used on mobile devices, of users, thanks to an application that configures the device for the correct reception of data: above mentioned streaming system of multimedia contents being independent from the user's infrastructure; above mentioned system being composed of four main elements: (A) a main broadcasting module installed on a dedicated computer with access to both the multimedia contents source and at least one wireless router; above-mentioned main module receiving the multimedia stream from any source, including but not limited to: local storage media/supports, file server over LAN or remote web, Internet, real-time streaming, audio/video recording devices; above mentioned module preparing above mentioned transmission stream and sending it to users on the dedicated Wi-Fi channel; above-mentioned module encapsulating the incoming multimedia content in a new stream in real time, with characteristics suitable for multicast transmission, including: a) use of an appropriate codec to reduce bandwidth usage; b) formatting of packets in UDP/IP multicast; c) application of an FEC algorithm to mitigate the intrinsic losses of the wireless channel; this FEC algorithm (Forward Error Correction) allowing to identify and correct possible errors due to the noise of the channel through three elements:
sending the same UDP datagram up to four times (redundancy), to allow the applications on the station to keep the datagrams in a buffer from which they retrieve the first datagram correctly received;
an algorithm, incorporated in the mobile application of the receiving station, which takes care of recovering any missing datagram by interpolation on the entire received flow (best guess);
a noise suppression algorithm that detects and discards any other undesired signal; (B) an automatic configuration module of the Wi-Fi network installed on the same computer of the broadcasting module or on a different device connected to the first one; above-mentioned configuration module automatically specifying an appropriate configuration for the network devices to be used; above-mentioned configuration being performed only once, at the installation of the system; above-mentioned module including an additional network diagnostic feature that indicates whether the hardware is compatible with the system; above-mentioned Wi-Fi network configurator instructs network equipment to:
forward the media stream in UDP/IP multicast mode;
simultaneously recognize and accept a large number of users;
allow the coexistence of one or more Wi-Fi networks, guaranteeing the non-interference with existing services;
recognize the request from the user's device to access the network by entering its IP address in the list of system users;
enter the MAC (Media Access Control) address of the device in its Client List Journal;
switch the connection of the device in IP multicast mode in order to receive multimedia streams;
(C) an automatic application configuration module designed for mobile platforms in order to prepare and configure the applications used for multimedia flows reception; above-mentioned module being directly installed on the mobile device;
(D) a control and configuration module which allows, through a simple graphic interface: a) to select the source of the multimedia content to be sent to the broadcasting module; b) to configure all system settings; c) to access the analysis and reporting functions; d) to manage the contents to be distributed; e) to monitor ongoing activities; f) to create event codes to allow the user to select the contents to be received; g) to enable a special test mode to verify the accuracy of the system settings; h) to receive and send instant messages.

2. The end-to-end system for the distribution of multimedia contents over a Wi-Fi network, according to the previous claim 1, wherein the above mentioned system includes at least one audio/video recording station and an acquisition system for at least one speaker and at least one station for local or remote simultaneous interpreters or translators; above mentioned system being used to create a simultaneous translation system for events or conferences; above mentioned system also allowing each user, via mobile application, to speak and interact during the event.

3. The end-to-end system for distributing multimedia contents over a Wi-Fi network, according to claim 1, wherein the above mentioned system is implemented using an ad hoc created hardware which includes at least one router/AP and at least one mini-PC integrated in a single case; such mini-PC performing the functions of broadcasting, of Wi-Fi configurator, and of dashboard; above mentioned hardware including as internal storage—a media server where multimedia contents can be retrieved; above mentioned case including a variable number of connections for external peripherals arranged on the rear panel of the case; above mentioned system being completely self-sufficient and ready to be used without further configuration or user's intervention.

4. The end-to-end system for distributing multimedia contents over a Wi-Fi network, according to claim 1, further comprising a mobile application to be installed on the user's device; above mentioned application allowing to receive the multimedia stream transmitted by the broadcasting module through the Access Point on the personal device; above mentioned application also allowing to select the preferred event, the possible language in case of simultaneous translation or to configure the listening settings.

5. The-to-end system for the distribution of multimedia contents over a Wi-Fi network, according to claim 1, wherein above mentioned system includes at least one connection to the Internet and at least one multimedia server accessible via above mentioned connection; above mentioned system can therefore be used in any place or situation and recover the multimedia flows from said remote server.

6. The end-to-end system for distributing multimedia contents over a Wi-Fi network, according to claim 1, wherein the above mentioned system includes at least one module dedicated to audience control, installed on the same computer as the broadcasting module or on another local support; above mentioned audience control module providing real-time information about a series of parameters, including but not limited to: Wi-Fi network status, number of connections, signal quality, bandwidth usage; above mentioned information allowing the operators, through the control module, to intervene with punctual modifications and calibrations to maximize the service quality; above mentioned audience control module also recording information related to users' behaviour during the use of the system; this information can be used for profiling purposes and to more effectively convey the contents, or for commercial and advertising purposes.

7. The end-to-end system for distributing multimedia contents over a Wi-Fi network, according to claim 1, wherein above-mentioned system includes one or more high-power wireless repeaters to be used in open spaces.

8. The end-to-end system for distributing multimedia contents over a Wi-Fi network, according to claim 1, wherein the system includes at least one multimedia server with educational and illustrative contents suitable for use in public spaces.

9. The end-to-end system for distributing multimedia contents over a Wi-Fi network, according to claim 2, wherein the above mentioned system is implemented using an ad hoc created hardware which includes at least one router/AP and at least one mini-PC integrated in a single case; such mini-PC performing the functions of broadcasting, of Wi-Fi configurator, and of dashboard; above mentioned hardware including as internal storage—a media server where multimedia contents can be retrieved; above mentioned case including a variable number of connections for external peripherals arranged on the rear panel of the case; above mentioned system being completely self-sufficient and ready to be used without further configuration or user's intervention.

10. The end-to-end system for distributing multimedia contents over a Wi-Fi network, according to claim 2, further comprising a mobile application to be installed on the user's device; above mentioned application allowing to receive the multimedia stream transmitted by the broadcasting module through the Access Point on the personal device; above mentioned application also allowing to select the preferred event, the possible language in case of simultaneous translation or to configure the listening settings.

11. The end-to-end system for distributing multimedia contents over a Wi-Fi network, according to claim 3, further comprising a mobile application to be installed on the user's device; above mentioned application allowing to receive the multimedia stream transmitted by the broadcasting module through the Access Point on the personal device; above mentioned application also allowing to select the preferred event, the possible language in case of simultaneous translation or to configure the listening settings.

12. The-to-end system for the distribution of multimedia contents over a Wi-Fi network, according to claim 2, wherein the system includes at least one connection to the Internet and at least one multimedia server accessible via above mentioned connection; above mentioned system can therefore be used in any place or situation and recover the multimedia flows from said remote server.

13. The-to-end system for the distribution of multimedia contents over a Wi-Fi network, according to claim 3, wherein the system includes at least one connection to the Internet and at least one multimedia server accessible via above mentioned connection; above mentioned system can therefore be used in any place or situation and recover the multimedia flows from said remote server.

14. The-to-end system for the distribution of multimedia contents over a Wi-Fi network, according to claim 4, wherein the system includes at least one connection to the Internet and at least one multimedia server accessible via above mentioned connection; above mentioned system can therefore be used in any place or situation and recover the multimedia flows from said remote server.

15. The end-to-end system for distributing multimedia contents over a Wi-Fi network, according to claim 2, wherein the above mentioned system includes at least one module dedicated to audience control, installed on the same computer as the broadcasting module or on another local support; above mentioned audience control module providing real-time information about a series of parameters, including but not limited to: Wi-Fi network status, number of connections, signal quality, bandwidth usage; above mentioned information allowing the operators, through the control module, to intervene with punctual modifications and calibrations to maximize the service quality; above mentioned audience control module also recording information related to users' behaviour during the use of the system; this information can be used for profiling purposes and to more effectively convey the contents, or for commercial and advertising purposes.

16. The end-to-end system for distributing multimedia contents over a Wi-Fi network, according to claim 3, wherein the above mentioned system includes at least one module dedicated to audience control, installed on the same computer as the broadcasting module or on another local support; above mentioned audience control module providing real-time information about a series of parameters, including but not limited to: Wi-Fi network status, number of connections, signal quality, bandwidth usage; above mentioned information allowing the operators, through the control module, to intervene with punctual modifications and calibrations to maximize the service quality; above mentioned audience control module also recording information related to users' behaviour during the use of the system; this information can be used for profiling purposes and to more effectively convey the contents, or for commercial and advertising purposes.

17. The end-to-end system for distributing multimedia contents over a Wi-Fi network, according to claim 4, wherein the above mentioned system includes at least one module dedicated to audience control, installed on the same computer as the broadcasting module or on another local support; above mentioned audience control module providing real-time information about a series of parameters, including but not limited to: Wi-Fi network status, number of connections, signal quality, bandwidth usage; above mentioned information allowing the operators, through the control module, to intervene with punctual modifications and calibrations to maximize the service quality; above mentioned audience control module also recording information related to users' behaviour during the use of the system; this information can be used for profiling purposes and to more effectively convey the contents, or for commercial and advertising purposes.

18. The end-to-end system for distributing multimedia contents over a Wi-Fi network, according to claim 5, wherein the above mentioned system includes at least one module dedicated to audience control, installed on the same computer as the broadcasting module or on another local support; above mentioned audience control module providing real-time information about a series of parameters, including but not limited to: Wi-Fi network status, number of connections, signal quality, bandwidth usage; above mentioned information allowing the operators, through the control module, to intervene with punctual modifications and calibrations to maximize the service quality; above mentioned audience control module also recording information related to users' behaviour during the use of the system; this information can be used for profiling purposes and to more effectively convey the contents, or for commercial and advertising purposes.

19. The end-to-end system for distributing multimedia contents over a Wi-Fi network, according to claim 2, wherein above-mentioned system includes one or more high-power wireless repeaters to be used in open spaces.

20. The end-to-end system for distributing multimedia contents over a Wi-Fi network, according to claim 3, wherein above-mentioned system includes one or more high-power wireless repeaters to be used in open spaces.
